(19) United States
(12) Patent Application Publication
(10) Pub. No.: US 2016/0230039 A1
(43) Pub. Date: Aug. 11, 2016

(54) POLYHYDROXYALKANOATE FILM FORMATION USING ALKANOIC ACIDS

(71) Applicant: THE GOVERNORS OF THE UNIVERSITY OF ALBERTA, Edmonton (CA)

(72) Inventors: Anastasia ELIAS, Edmonton (CA); Preetam ANBUKARASU, Edmonton (CA); Dominic SAUVAGEAU, Edmonton (CA)

(73) Assignee: THE GOVERNORS OF THE UNIVERSITY OF ALBERTA, Edmonton (CA)

(21) Appl. No.: 15/040,579

(22) Filed: Feb. 10, 2016

Related U.S. Application Data
(60) Provisional application No. 62/114,418, filed on Feb. 10, 2015.

(51) Int. Cl. C09D 167/04; C08J 5/18; C08G 63/06

(52) U.S. Cl. CPC C09D 167/04; C08G 63/06; C08J 5/18; C08J 2367/04

(57) ABSTRACT

A method of forming a polymer film, coating or particle comprising a polyhydroxyalkanoate such as polyhydroxybutyrate, comprising the step of dissolving the polymer in a solvent comprising an alkanoic acid such as acetic acid, and drying or precipitating the dissolved polymer.

### FIELD OF THE INVENTION

The present invention relates to biodegradable polymer thin films and coatings, and methods of producing the same.

### BACKGROUND

Polyhydroxybutyrate (PHB) is a polymer of bacterial origin that can be broken down by enzymes known as PHB depolymerases. Pure PHB can be degraded by a variety of enzymes over a broad range of temperatures, resulting in non-toxic degradation products. It is a biodegradable and food-safe alternative to petroleum-based polymers. PHB also has the potential for use in medical applications and food packaging materials.

Despite these advantages, the challenges in processing PHB into flexible, thin films is one of the main factors that prevent its widespread application. Its high melting point (˜175° C. to 180° C.) and low degradation temperature (˜220° C.) limit the possibility of thermal processing to prepare PHB films. Approaches such as heat treatment, co-polymerization, blending and the addition of plasticizers have been used to improve thermal processability. By using a combination of approaches mentioned above, PHB can be extruded, rolled or pressed into films having reasonably good mechanical properties.

Thermal processing assisted by additives is the most cost effective and industrially relevant approach for large-scale production of PHB films. However, many of the additives that improve thermal processing also reduce biodegradation rates, increase cost, generate toxic degradation products or cause health hazards related to leaching of plasticizers. Recent works are exploring eco-friendly plasticizers, green polymer blend, composites and additives to overcome these drawbacks, but some issues with using additives still exist. Films produced by thermal processing can also have limited flexibility and optical clarity, even in the presence of plasticizers and additives. Such limitations are acceptable in some applications, such as compostable bags and disposable containers. However, for other specialized applications—such as bio-medical implants and optical films, which require PHB with properties including low thickness, high porosity, and optical clarity—alternative processing routes that offer more flexibility in processing conditions and PHB properties are necessary.

One such approach for fabricating polymer films is to use a solvent casting process, which involves dissolving the polymer in a suitable solvent and evaporating the solvent to obtain a high-quality film. Solvent casting may enable tunability of mechanical and optical properties of the film through the variation of processing parameters such as solvent casting time and temperature. The solvent casting process is capable of producing thin films that have high optical clarity and porous films that can degrade rapidly under the proper physiological conditions. Despite these advantages, the added costs and hazards that come with solvents have limited solvent casting to niche applications such as cellulose triacetate films for photographic sheets and polyvinyl alcohol films for polarizers in liquid crystal displays.

To produce continuous films that have good mechanical properties, a compatible solvent that has a similar solubility parameter to PHB is necessary. Chloroform is one of the most compatible and most commonly used solvents. However, chloroform is believed to be a damaging chemical to the environment and human health. In addition, the high affinity of PHB to chloroform can cause traces of chloroform to remain in the polymer even after long aging times, which could prove to be a health risk in medical implants and food packages. The potential for PHB to be used in food packaging and for medical applications makes it even more desirable to find food-safe and risk-free solvents.

Therefore, there is a need in the art for an alternative solvent for PHB, that is more environmentally friendly and food safe than chloroform, without compromising the properties of PHB film.

### SUMMARY OF THE INVENTION

In one aspect, the invention comprises the use of an alkanoic acid as a solvent to dissolve and process a polyhydroxyalkanoate, such as PHB. The polymer films cast with alkanoic acids are found to have comparable mechanical properties to films cast with chloroform. The results showed that crystallinity, mechanical properties and surface roughness of the polymer can be tuned by changing solvent casting temperature, solvent evaporation rate and the film cooling rate. The alkanoic acids which may be used are for example acetic acid, propionic acid, butyric acid, valeric acid

In another aspect, PHB which has been solvent cast in an alkanoic acid comprises a novel crystalline modification which is distinguished by its smooth and uniform surfaces. In one embodiment, the solvent cast PHB has a characteristic peak at 2θ=16.2° in the X-ray diffraction pattern.

In one embodiment, the PHB/acetic acid system enables at least partial control of the microstructure, phase separation and crystallization behavior of PHB films. In one embodiment, PHB films and coatings may be prepared by solvent casting process at different temperatures ranging from about 25° C. to about 180° C. Equivalent results can be obtained by reducing the casting temperature and changing the pressure at which the solvent casting is carried out.

The variation in crystallinity, mechanical properties and surface morphology of PHB films cast from acetic acid with respect to solvent casting temperature was characterized and compared to PHB film cast using chloroform as solvent. Results revealed that the crystallinity varies with changing solvent casting temperature. In general, samples processed with acetic acid at relatively lower temperature had comparable mechanical properties to PHB cast using chloroform at room temperature.

### BRIEF DESCRIPTION OF THE DRAWINGS

In the drawings, like elements are assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention. The drawings are briefly described as follows:

FIG. 1. Schematic of PHB film preparation by solvent casting, a) dissolution of PHB using acetic acid at 118° C., b) pouring of polymer solution on glass slide, c) drying of PHB, and image shows the film after drying.

FIG. 2: Images of PHB films processed at different temperatures overlaid on the right side (separated by lines) of a printed pattern, demonstrating the translucency of PHB films. Results from a film processed using chloroform (CF) is shown for comparison. The film thickness of each sample was 40±10 μm.

FIG. 3. Optical transmittance vs. solvent casting temperature. The transmittance values were obtained at wavelengths of 600 nm, 500 nm, 400 nm and 300 nm. The inlay shows the images of transmitted laser beam after passing through the PHB films, arranged from lowest processing temperature (left) to highest processing temperature (right).

FIG. 4: Stereomicroscope images of the PHB films solvent cast at different temperatures using acetic acid as a solvent. False-colored images (lower rows) show the undulations and macroscopic features on the surface, which indicate the presence of two distinct regions in the samples. A sample processed with chloroform (CF) as the solvent is shown for comparison.

FIG. 5. Percent crystallinity with respect to the processing temperature. The straight line at the bottom indicates the crystallinity of PHB prepared using chloroform at room temperature.

FIG. 6. Combined XRD plot of PHB processed in acetic acid (AA) at different temperatures. The pattern obtained from PHB prepared with chloroform (CF) is shown at bottom for comparison.

FIG. 7: TGA plot of PHB films prepared under different conditions: solvent cast in chloroform (CF), solvent cast in acetic acid at 80° C., and solvent cast in acetic acid at 160° C. The upper and lower horizontal lines correspond to 95% normalized mass and 5% normalized mass respectively, while the vertical lines indicate the thermal degradation onset temperature (Ti) and the complete degradation temperature (Tc) of each sample.

FIG. 8: Combined plot of the DSC melting curves for PHB samples prepared at different temperatures in acetic acid. The as-received sample and sample solvent cast using chloroform (CF) are also shown for comparison. All samples were tested at a scan rate of 20° C./min (endothermic down).

FIG. 9: Mechanical characterization of PHB films prepared in acetic acid (AA) at different casting temperatures. (a) Strain to failure vs. casting temperature, (b) Elastic modulus vs. processing temperature, (c) Ultimate tensile stress vs. processing temperature, (d) Representative stress-strain curves. Average values and standard error are shown in (a-c) and are based on at least 4 measurements. Results from samples cast with chloroform (CF) are also shown for comparison.

FIG. 10: AFM scans of PHB samples processed at different temperatures in acetic acid (AA) or chloroform (CF). Scan area: 20 μm². The topography scale is ±120 nm for all acetic acid-processed samples, and ±1000 nm for the chloroform-processed sample.

FIG. 11: RMS roughness of PHB films solvent cast with acetic acid with respect to the processing temperature.

FIG. 12: Ensemble of different forms of PHB produced using acetic acid as a solvent. (a) Porous PHB by rapid removal of solvent, (b) spray coated PHB layer on a glass substrate, (c) PHB thin films that have different optical transmittance. Films prepared at different acetic acid concentrations at 80° C. (optical transmittance decreases from left to right), (d) Flexible PHB films prepared by solvent casting from acetic acid.

### DETAILED DESCRIPTION OF EMBODIMENTS

The present invention comprises a method of using an alkanoic acid as a solvent for preparing polyhydroxyalkanoate films, coatings, particles and porous structures. In particular, the inventors describe the use of acetic acid as a solvent to dissolve and process PHB through solvent casting. All terms used herein which are not specifically defined have the commonly accepted meaning known to those skilled in the art. References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

As used herein, a polyhydroxyalkanoate may be a linear polyester, known to be produced in nature by microorganisms. These polymers are biodegradeable and are used in the production of bioplastics. Polyhydroxyalkanoates may include polyhydroxybutyrates such as poly-3-hydroxybutyrate (P3HB) or poly-4-hydroxybutyrate (P4HB), polyhydroxyvalerate (PHV), polyhydroxyhexanoate (PHH), polyhydroxyoctanoate (PHO), and their co-polymers. They can be either thermoplastic or elastomeric materials, with melting points ranging from 40 to 180° C. The structure of poly-3-hydroxybutyrate (P3HB) is shown below:

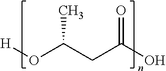

The molecular weight of the polyhydroxyalkanoate may vary from about 1000 to about 1×10⁸ g/mol

As used herein, an alkanoic acid may include linear or branched alkanoic acids such as formic acid, acetic acid, propanoic acid, butanoic acid, pentanoic acid, or hexanoic acid. In one embodiment, the alkanoic acid comprises acetic acid.

Acetic acid is cost effective, safe to handle and easy to recover, as demonstrated by its extensive use in the synthesis of polymers such as cellulose acetate and polyvinyl acetate. Although acetic acid is not the most compatible solvent for PHB, its relatively high boiling point (118° C.) enables dissolution and processing of PHB at elevated temperatures. The incompatibility of acetic acid also allows at least partial control of both the microstructure and properties of the films by taking advantage of the phase separation and crystallization behavior exhibited by the PHB/acetic acid system.

In general terms, the invention comprises a method of preparing a polyhydroxyalkanoate film, such as from PHB, comprising the step of dissolving the polymer in a solvent comprising an alkanoic acid, such as acetic acid. The acetic acid may range in concentration from about 80% wt. in another compatible solvent, such as another alkanoic acid, to glacial acetic acid (˜99% wt). PHB can be solvent cast into films using acetic acid as a solvent, with only a marginal decrease in thermal stability.

Dissolution of the PHB into the solvent may be accelerated by heating the solvent, for example up to the boiling point of the solvent. In one embodiment, the PHB may be mixed with glacial acetic acid and dissolved by heating with stirring. Preferably, the acetic acid is heated to boiling and covered with constant stirring until the polymer is completely dissolved. In one embodiment, the acetic acid may be heated and the dissolution step may occur in a pressurized container at temperatures above 118° C. In one embodiment, the resulting concentration of PHB in acetic acid may vary from about 1 nanogram/ml to about 10 g/ml. Preferably, the concentration may range from about 0.01 g/ml to about 3 g/ml of acetic acid. Generally, PHBs with lower molecular weights may be more soluble than higher molecular weight polymers.

Once dissolved, the solution may then be used to solvent cast the polymer. A volume of the polymer solution may then be brought to the desired casting temperature by being poured onto a casting substrate, which may be pre-heated to the desired casting temperature. The casting temperature may vary from about 20° C. to about 180° C., preferably in the range of about 80° C. to about 160° C. The different solvent casting temperatures enable control of the solvent evaporation rate and cooling rate. These factors affect microscopic features namely: 1) crystallinity, 2) nature and orderliness of the crystals, and 3) fraction of stable/metastable crystals. These microscopic features lead to differences in properties of the resulting material.

The solvent casting continues until substantially all the solvent has evaporated, leaving the solid polymer. The solvent casting time may vary, depending at least in part on the boiling point of acetic acid (118° C.). Films cast at temperatures above 118° C. may require little or no drying time, while those cast at temperatures below 118° C. may require additional drying time.

Films prepared using acetic acid were found to have comparable properties to the films prepared using chloroform at room temperature, as an example of processing PHB using a halogenated solvent. In one embodiment, the processing time may be significantly reduced when using the alkanoic acid, which may make this method more suitable for industrial scale production of PHB films. In some embodiments, modifications of processing conditions may allow the ability to tune properties of the film.

In general, at lower casting temperatures, for example below the boiling point of the solvent, the solvent evaporates slowly, and there is limited thermal energy available for crystallization. Films, therefore, have lower crystallinity, good mechanical properties (in terms of tensile strength and strain to failure), and reasonable optical transmittance. However, films processed at lower temperatures have rougher surfaces both at the macroscopic and microscopic scale due to variations in thickness resulting from phase separation, and to inhomogeneities caused by the limited thermal energy available for crystallization. On the other hand, higher solvent casting temperatures, such as those above the boiling point of the solvent, yield films that are more crystalline, more transparent, and have higher surface uniformity. However, these films have relatively lower tensile strength and strain, Accordingly, the proper selection of casting temperature and solvent evaporation rate can be used to achieve films with a desired set of properties.

In one embodiment, the PHB film or coating may have greater crystallinity than the crystallinity of PHB produced from a solution in chloroform at 20° C., as demonstrated by the data discussed herein.

In one embodiment, the PHB film or coating has a different crystal structure than that produced when PHB is solvent cast using chloroform at 20° C. X-ray diffraction studies show that PHB solvent cast from acetic acid has a characteristic X-ray diffraction peak at a 2θ value of 16.85° and a suppressed peak at a 2θ value of 16.2°. PHB films produced by solvent casting in chloroform at room temperature display a peak at a 2θ value of 16.2°. The intensity of the peak at 16.85° varies with the casting temperature.

In one embodiment, optical transmittance may be varied by varying the casting temperature. In another embodiment, a polymer film having high porosity may be produced by rapid phase separation of the polymer and the solvent, either by introduction of a non-solvent such as water to precipitate the polymer, or a rapid change in pressure and/or temperature. Porous PHB may be useful in filtration applications, packaging materials, in bio-implant and in biomedical applications, because of its rapid and controllable degradation behavior.

Once the PHB is dissolved in the solvent, different processing routes known to those skilled in the art, such as spin-coating and spray-coating, could be used to form films or coatings with varying porosities and thicknesses. In one embodiment, a polymer solution may be used to spray coat a thin layer of polymer onto any suitable substrate, such as glass, paper or other plastic surfaces using conventional spray coating methods. Such varied forms of PHB can find potential applications as biological scaffolds, packaging materials, sensing devices and as enzyme activity screening assays.

The method of using acetic acid may prove to be an environmentally friendly route to make high quality, flexible PHB films both at industrial and laboratory scales for applications, such as, without limitation, bio-implants, surgical films and bio-degradable food packaging.

In another embodiment, an additive such as a pigment, plasticizer or property modifier, or combinations of additives, may be added to the solution prior to the film or coating formation step, and thus be incorporated into the resulting film or coating.

### Examples

The following examples describe specific work done to develop and characterize embodiments of the present invention, and are not intended to be limiting of the claimed invention.

Appearance of PHB Films.

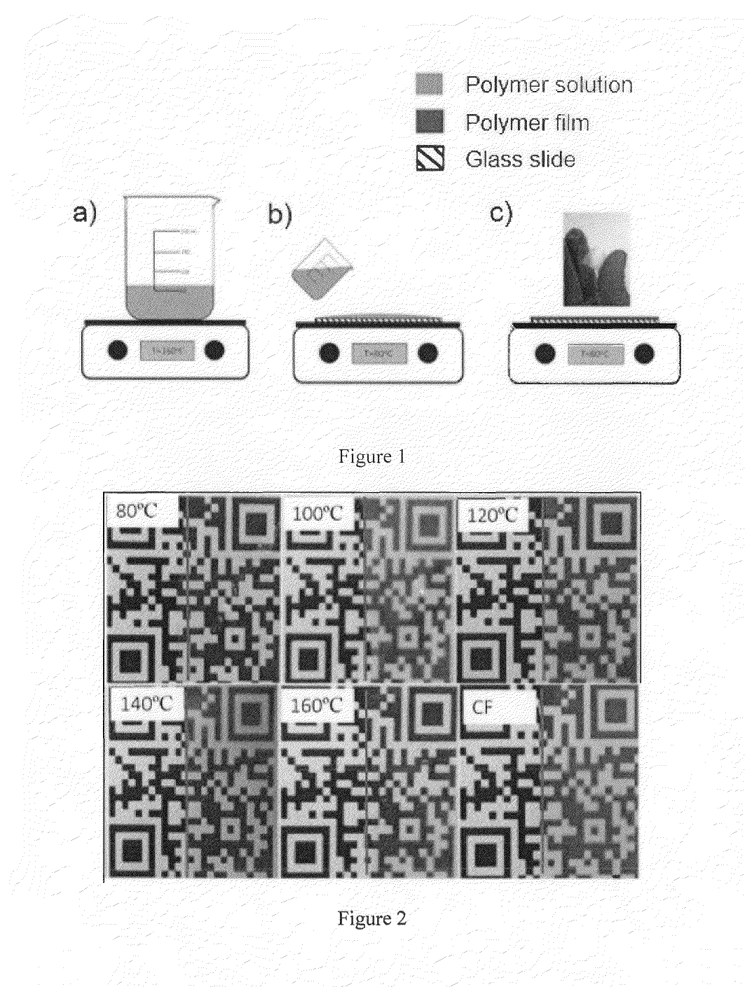

PHB films prepared at different temperatures using acetic acid as a solvent were translucent. FIG. 2 show images of PHB films—prepared at various casting temperatures—placed on a printed pattern. The samples processed at 80° C., 140° C. and 160° C. were more transparent than the ones processed at 100° C. and 120° C. The samples prepared using chloroform at room temperature were found to have similar optical transmittance to samples prepared with acetic acid at 100° C. and 120° C.

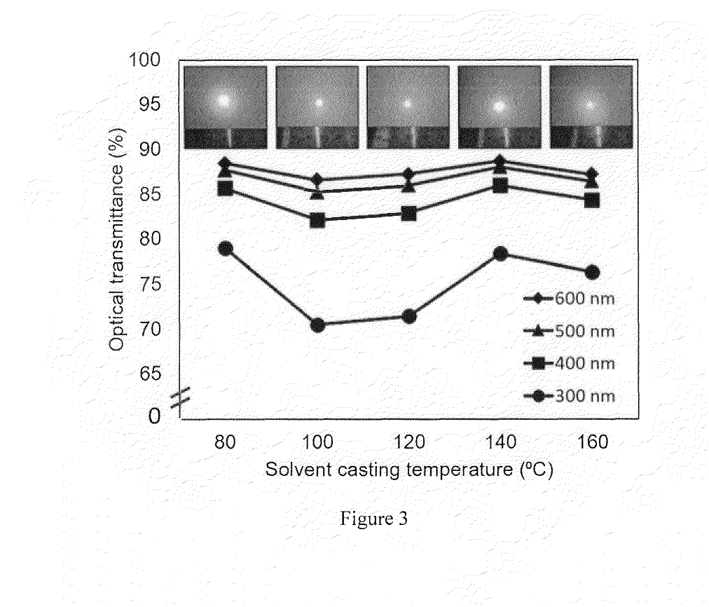

FIG. 3 shows a plot of optical transmittance of the film at different incident light wavelengths vs. solvent casting temperature. All films had relatively high optical transmittance (>82%) in the visible portion of the spectrum. The optical transmittance at all wavelengths was found to follow a parabolic trend, with lowest (80° C.) and higher processing temperatures (140° C. and 160° C.) resulting in films with higher optical transmittance. The films processed at intermediate temperatures had the lowest transmittance, indicating that they scatter, absorb and/or reflect the most light. As these films were observed to have the most uneven surfaces, this reduced transmittance can be attributed mainly to light scattering from the surface. The inlay in FIG. 3 shows images of a transmitted laser beam (λ=532 nm) after it passed through the PHB films, cast at different temperatures. These images show that the samples prepared at 100° C. and 120° C. had a relatively small specular beam and substantial scattering. This behavior is in agreement with our observations of the uneven and cloudy appearance of these films.

The cloudy appearance can be attributed to scattering of light at the interface of crystalline-amorphous regions, and the presence of residual solvent—which can remain in samples even after long aging periods.

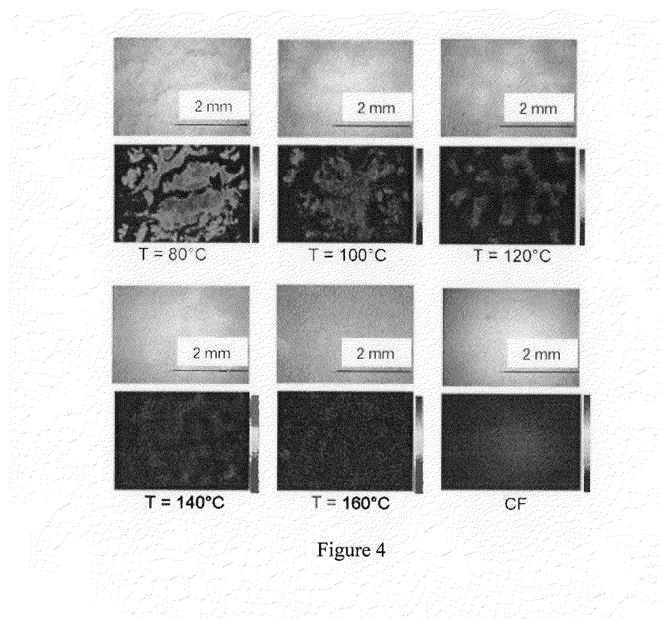

The concentration of residual solvent is expected to be higher in samples processed with chloroform compared to those processed with acetic acid since chloroform interacts more strongly with PHB than acetic acid. We also found that the samples prepared at high casting temperatures were more homogenous while samples prepared at lower temperatures had a patchy appearance. FIG. 4 shows stereomicroscope images of samples prepared using acetic acid. False-colored images are also shown to emphasize the undulations and features on the surface. The images indicate the presence of two distinct types of regions in the films, which were more apparent in the samples prepared at lower temperatures. Increasing the processing temperature resulted in more homogenous surfaces. Samples prepared at 160° C. were very smooth and had no undulation on the surface.

The variations in appearance and the presence of two types of regions in the samples can be explained by the fact that acetic acid, thermodynamically speaking, is a “poor” solvent for PHB. This can lead to solvent/polymer phase separation and the formation of polymer-rich and polymer-poor zones in the sample as the solvent evaporates. The polymer-rich regions—by virtue of having more polymer per unit volume—will have a higher average thickness than polymer-poor regions. Therefore, the polymer-rich zones can appear to be cloudier than the polymer-poor zones after complete evaporation of the solvent. Such local segregation of polymer-rich and poor regions can influence the localized solvent evaporation rate and polymer concentration, which in turn can affect properties such as the crystallization behavior, the thermal and mechanical properties.

In contrast, the samples processed with chloroform, which were cast at room temperature, had a much smoother appearance, owing to the fact that the solvent evaporation rate was much slower. The higher chemical compatibility of PHB and chloroform also limits the extent of phase separation and the consequent roughening of the surface due to mismatch stresses.

Crystallinity.

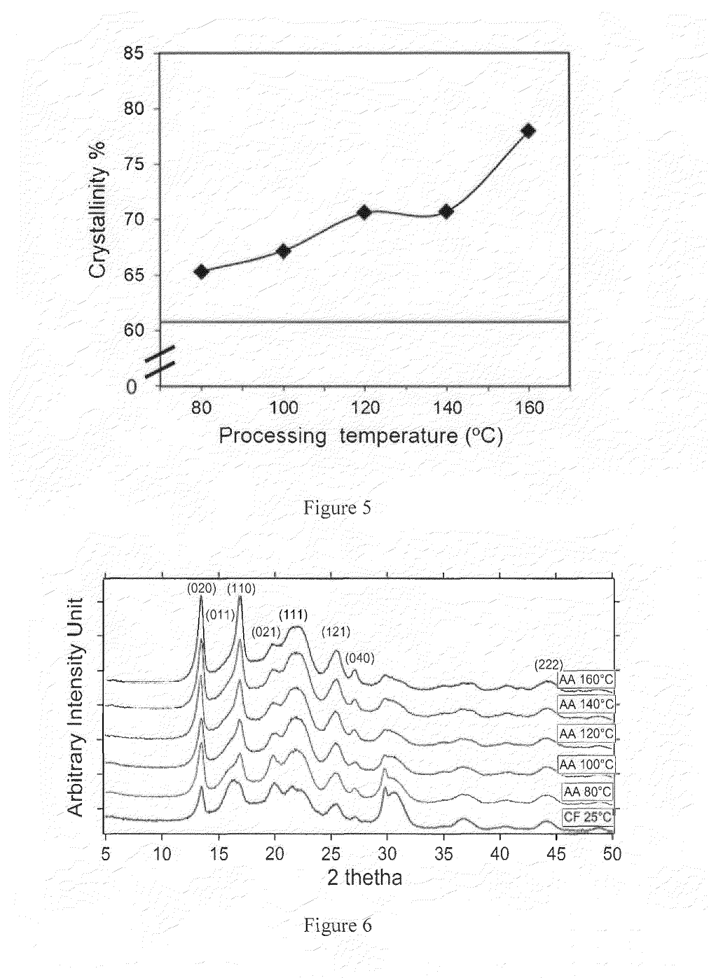

FIG. 5 shows a plot of percent crystallinity (estimated from X-ray diffraction (XRD)) as a function of processing temperature and compared to a control sample prepared at room temperature using chloroform as a solvent. The analysis of XRD diffraction peaks revealed that the crystallinity of PHB prepared using acetic acid ranged from 64% at 80° C. to 78% at 160° C.; whereas, the crystallinity of PHB processed with chloroform was approximately 60.5%. The use of glancing incidence angle and deconvolution function to calculate the contribution of amorphous regions in the polymer introduces peak broadening, and systematic instrumental error in the crystallinity values obtained using this method. Therefore, the crystallinity values are suitable only for comparison with other samples studied in this work and could deviate from absolute crystallinity values. Nonetheless, a clear trend is seen: all samples prepared using acetic acid have a higher crystallinity than the sample prepared with chloroform. This trend can be attributed to two main factors: (1) acetic acid-processed samples were cast at higher temperatures than the chloroform samples. Therefore, more thermal energy was available for the formation and growth of crystalline structures. (2) Chloroform is a “better” and more compatible solvent for PHB; residual solvent in the sample can increase polymer chain mobility and suppress crystal growth. The PHB samples processed with acetic acid also exhibited increased crystallinity with increased processing temperature, reflecting that more thermal energy resulted in a more ordered structure.

Further examination of the structure of the films by XRD revealed that not only the percent crystallinity varied as a function of temperature, the type of crystals formed varied as well. A combined plot of XRD pattern of PHB films prepared at different solvent casting temperatures using acetic acid and chloroform as a solvent is shown in FIG. 6. A general increase in intensity is seen as a function of processing temperature, reflecting the previous results.

Peaks corresponding to orthorhombic crystal planes (020), (110), (021), (111), (121), (040) and (222) at 2θ values of 13.5°, 16.85°, 19.8°, 21.4°, 25.5°, 27.2° and 44°, respectively, were found to be similar for all samples. However, the peaks corresponding to (011) at 2θ=16.2° had much lower intensity in all acetic acid-processed samples than in chloroform-processed PHB. This indicates that the (011) plane orientation is suppressed when PHB is processed using acetic acid at higher temperatures, suggesting the presence of a preferred orientation of crystals within the samples. The lattice parameters and the peak locations for all the samples were found to be similar, indicating that the orthorhombic PHB crystals did not change substantially with increasing processing temperature.

Thermal Degradation.

One important consideration when choosing acetic acid as a solvent for PHB is the possibility of polymer degradation through acid hydrolysis during processing. PHB is known to degrade into smaller units by random scission of ester bonds when exposed to acidic solutions. Moreover, the use of high processing temperatures can accelerate this reaction and decrease the thermal stability of the sample. Therefore, we analyzed the extent of PHB degradation caused by acetic acid using thermogravimetric analysis (TGA).

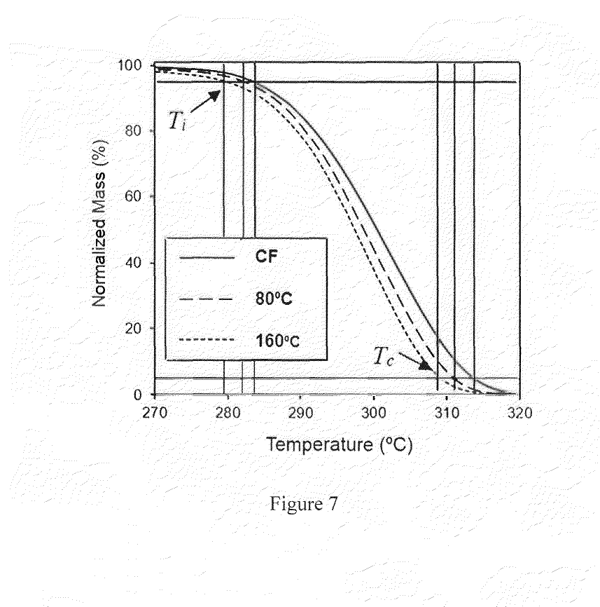

FIG. 7 shows a combined plot of TGA carried out on samples solvent cast using acetic acid at two different temperatures compared with samples cast using chloroform at room temperature. The figure also indicates the temperature at which the samples lost 5% of their mass (thermal degradation onset temperature (Ti)) and the temperature at which samples lost 95% of their mass (complete degradation temperature (Tc)). We used Ti and Tc of the samples to determine the effect of acetic acid processing and temperature on PHB. We also obtained the TGA profile of PHB prepared with chloroform for comparison with acetic acid-processed samples. The samples cast from acetic acid had lower Ti and Tc than the sample cast from chloroform. These results indicate that the use of acetic acid as a solvent and higher casting temperatures can cause mild hydrolysis and degradation of PHB. We found that the Ti and Tc were marginally lower for the sample processed at 160° C. (279° C. and 308° C., respectively) compared to the sample processed at 80° C. (283° C. and 312° C., respectively). The slope of the weight loss curves with respect to temperature was found to be very similar for samples prepared at 80° C. and 160° C. (the difference in slope is close to the instrumental limit). The samples prepared using acetic acid were dissolved at elevated temperatures for ˜1 hour, while the solvent casting process itself lasted only a few minutes, which explains why both the slopes and the temperature at which the degradation is complete (100% mass loss) are similar for these samples. In contrast, the sample cast from chloroform had a lower slope and reached 100% mass loss at a slightly higher temperature. These factors also indicate that the samples prepared using acetic acid as solvent underwent slight degradation (and likely experienced a small decrease in molecular weight mainly during the dissolution process), while the solvent casting step did not cause much change because of the short thermal exposure time.

Overall, the acetic acid processing route used in this work did not cause substantial degradation and more importantly allowed for the production of free-standing thin films that have good thermal stability.

Melting Behaviour

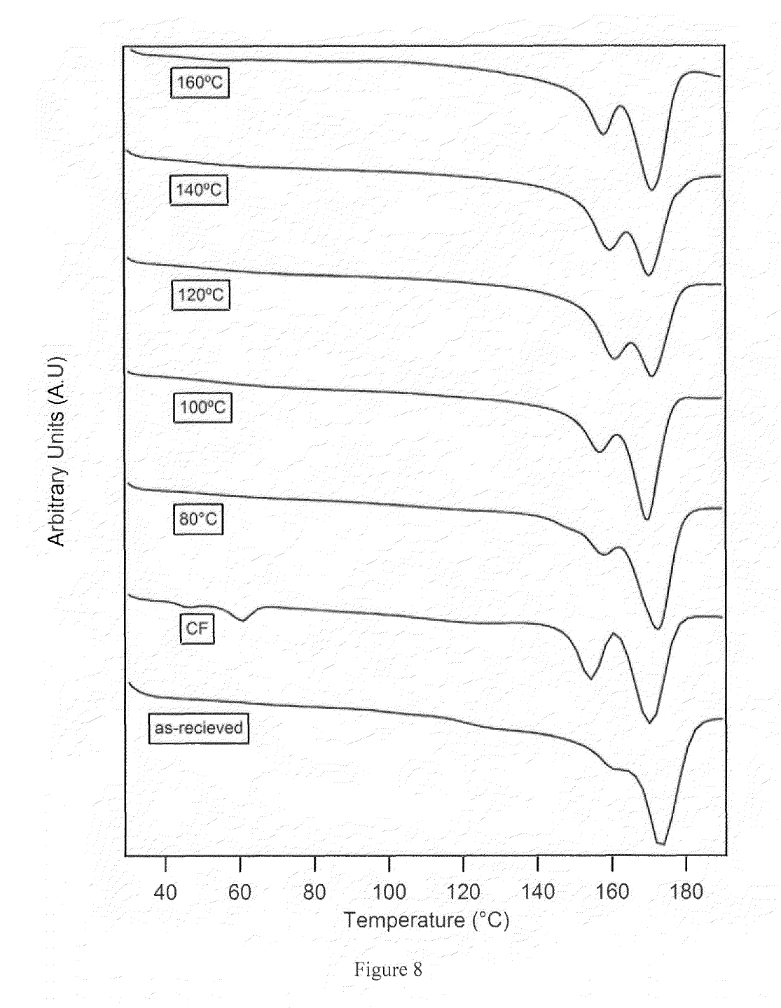

The melting behavior of the PHB films was determined using DSC. The melting curves of the films prepared with acetic acid at different temperatures are shown in FIG. 8. The melting endotherm consisted of two distinct peaks for all processed PHB samples while the as-received material exhibited a large peak with a small shoulder at a lower temperature. The double melting behavior is quite common in polymeric materials and has been explained based on two theories: namely, the melting and recrystallization model and the double lamellar thickness population model. Previous works have reported the double-melting behavior for PHB and have shown that it occurs according to the melting and recrystallization model as observed by the change in the shape of the endotherms at different heating rates.

The magnitude of the low-temperature endotherm is directly related to the amount of as-formed metastable crystals while the high-temperature endotherm corresponds to the melting of ordered crystals.

From the DSC curves, we observed that the magnitude of the first endotherm followed a parabolic trend with increasing processing temperature (the magnitude of the endotherm increased from 80° C. to 140° C. but decreased for samples prepared at 160° C.). The presence of such metastable as-formed crystals can be attributed to the phase-separation behavior exhibited by the PHB/acetic acid system. The presence of polymer-rich and polymer-poor regions cause localized variations in polymer chain mobility (polymer-rich regions have low mobility) and solvent evaporation rate (polymer-rich regions have slower evaporation rate), which in turn can influence the nature of ordered crystals formed during the solvent evaporation process. The mechanism of phase separation can also influence the orderliness of the crystals, with nucleation and growth mechanism allowing for the formation of highly ordered crystals and spinodal decomposition resulting in relatively disordered metastable crystals. The samples prepared at lower temperatures (80° C. and 100° C.) were more likely to phase separate by nucleation and growth, since the rate of change of polymer solution concentration is much lower and more time was available for the growth of the crystals. Therefore, a smaller fraction of metastable crystals was present, as shown by the relatively small amplitude of the first melting endotherm. As the temperature increased (e.g. to 120° C. and 140° C.), rapid de-mixing due to spinodal decomposition is expected to be the dominant mechanism of crystal growth, which results in the formation of more metastable crystals (and a relative increase in the magnitude of the first peak with respect to the second). As the temperature increased further (to 160° C.), the phase separation effect became less important because of the high solvent evaporation rate, and the availability of large amounts of thermal energy enabled the formation of highly ordered crystals at the expense of metastable crystallites (resulting in a larger second peak and a smaller first peak).

We also observe that the DSC heating curve for the sample prepared using chloroform consists of two melting peaks at approximately the same locations as the other samples. However, an additional endotherm at ˜60° C. was apparent. This peak matches with the evaporation temperature of chloroform, indicating that a small quantity of chloroform remained in the sample even after a long aging time. This could limit the applicability of chloroform-cast PHB films for use in packaging and other applications that involve direct contact with food or the body. The strong interaction between PHB and chloroform can also affect crystal formation. Therefore, the underlying crystallization conditions and structure of the samples solvent cast using chloroform would be much different from the samples cast using acetic acid.

Nonetheless, as for the samples cast from acetic acid, a large metastable peak is seen for these samples as well. These results suggest that all the samples (including those cast from chloroform) contain a mixture of stable and metastable crystallites, with intermediate processing temperatures resulting in more metastable crystals. Despite the fact that the samples cast from chloroform contained a significant fraction of both types of crystals, these samples were much smoother and uniform in appearance than the samples cast from acetic acid at low temperatures. The large fraction of metastable crystals in chloroform-processed samples can be explained by the low processing temperature, which limits the amount of thermal energy available for the formation of ordered crystals. The uniform surface, on the other hand, can be attributed to slow solvent evaporation rate and higher compatibility of PHB with chloroform. We expect that the proportion, quantity, and relative size of the different crystal types can influence the mechanical properties of the samples since stable and metastable crystals are expected to have different mechanical properties.

Mechanical Properties.

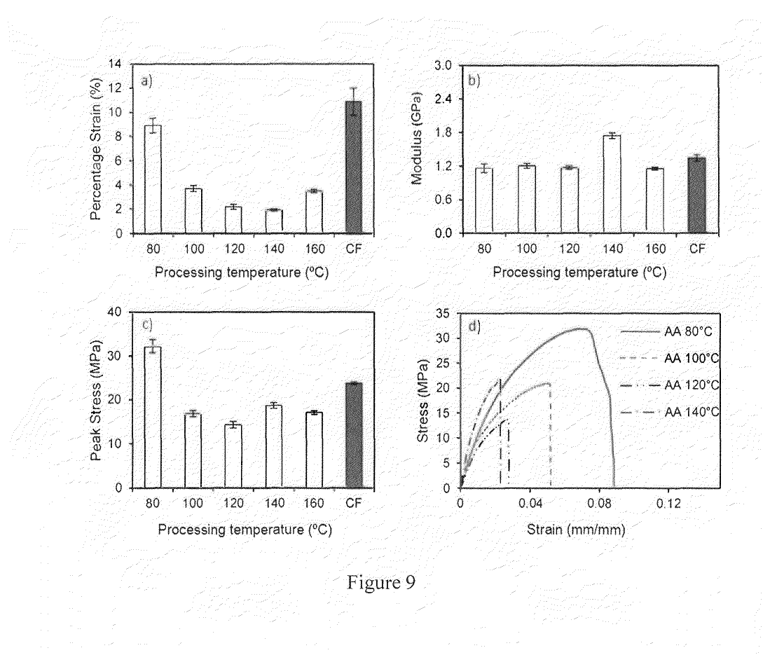

FIG. 9 shows plots of mechanical properties of PHB films solvent cast in acetic acid at different temperatures. Results from samples cast with chloroform at room temperature are also shown for comparison. In general, both the strain to failure and peak tensile stress were much higher for the films cast at 80° C. than at the higher processing temperatures. In contrast, the elastic modulus did not change substantially as a function of temperature, except at a processing temperature of 140° C. The decrease in strain to failure correlates well with the increase in crystallinity with processing temperature. The presence of amorphous regions (above the glass transition temperature) lends flexibility to the polymer. With increasing processing temperature, more crystallites are formed at the expense of amorphous regions, which results in increased brittleness of the polymer. The presence of a large number of crystallites has been shown to vitrify amorphous polymer chains. This vitrification further embrittles PHB and lowers the strain to failure and ultimate tensile stress. We attribute an almost constant elastic modulus to the low strain (0.5 mm/min) rate used for the tensile test. Low strain rates can have an effect analogous to deforming a polymer at elevated temperatures, where the elastic modulus decreases and converges to a minimum for a given strain rate. Low strain rates can also accommodate changes in the orientation of crystallites, which enables amorphous chains to elongate reversibly, especially at small strains (˜1%).

Interestingly, the samples prepared at 160° C. deviated from the general trend, exhibiting a higher strain at failure than samples cast at 120° C. and 140° C. This behavior could be attributed to partial melting and the consequent stress relaxation of PHB at 160° C. Although this processing temperature was lower than the melting point of PHB (˜180° C.), the melting process of PHB can begin at temperatures as low as 150° C., enabling a small proportion of the sample to melt and accommodate the stresses generated at the crystalline-amorphous interfaces. The stress relaxation effect can explain the increase in strain to failure for the samples prepared at 160° C., despite exhibiting much higher overall crystallinity than the rest of the samples. The relatively high strain to failure and ultimate tensile stress of samples processed at 80° C. can be explained by the low crystallinity.

Overall, the properties of the samples processed at all temperatures were comparable with those of the chloroform-cast films.

Surface Morphology and Roughness.

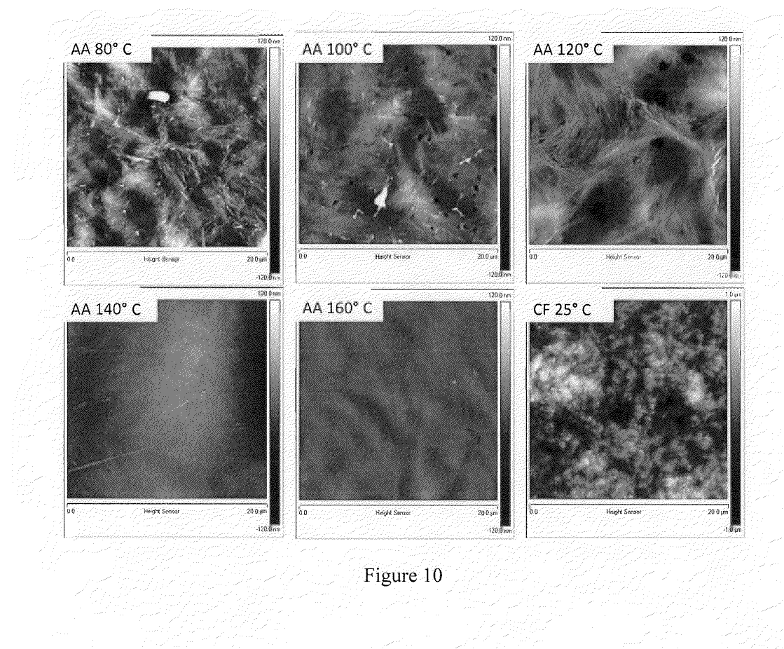

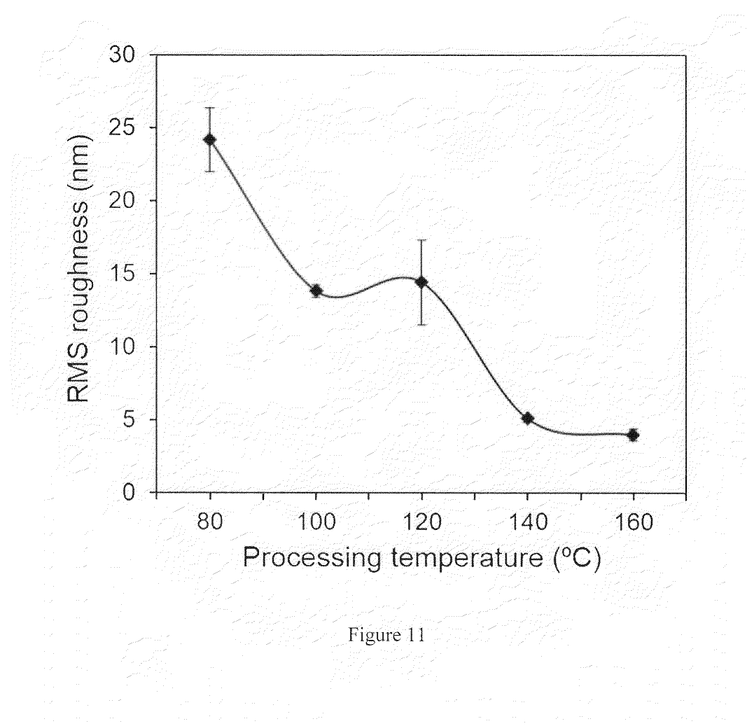

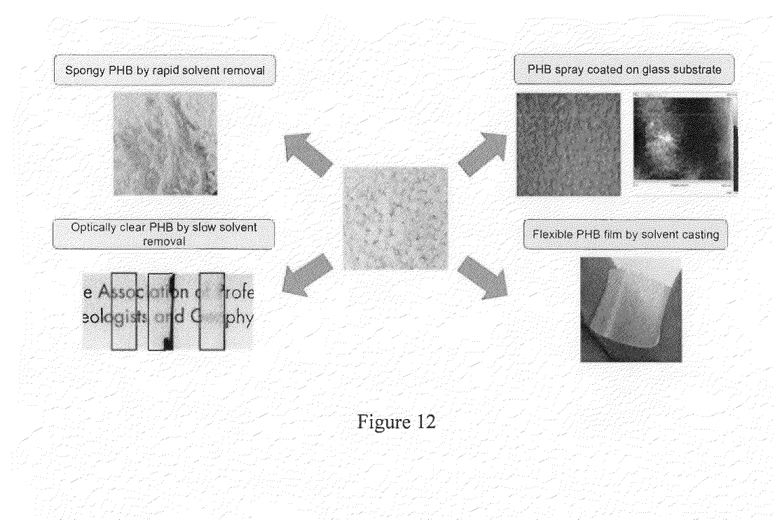

The surface morphology of the PHB films prepared at different temperatures is shown in FIG. 10; characterization was performed on the surfaces that were cast against a glass slide. The atomic force microscopy (AFM) images show a trend of decreasing roughness with increasing processing temperature. In addition to this, the samples processed with acetic acid have contrasting surface morphology from those processed with chloroform. We found that the PHB films prepared with chloroform had rough and globular structures on their surface. The samples processed with acetic acid at low temperatures had a fibrous, needle-like structures and roughness in the range of 20 nm, whereas the samples processed at high temperatures had smooth, uniform surfaces. The needle-like structures were likely caused by small crystallites and impurities on the surface. The RMS surface roughness with respect to solvent casting temperature is shown in FIG. 11 and was found to decrease progressively with increasing processing temperature. The RMS roughness of PHB prepared with chloroform was found to be in the range of 1 μm, which is over an order of magnitude greater than the samples prepared using acetic acid.

The increase in roughness with decreasing temperature can be explained by the fact that the polymer chains have less energy available to form ordered structures throughout the surface when processed at low temperatures. Therefore, more amorphous regions are present on the surface, along with the highly ordered crystallites. A large number of crystalline-amorphous interfaces can explain the increased roughness seen in PHB surface processed at room temperature using chloroform. In this case, small crystals and amorphous zones populated the surface.

The high surface roughness of chloroform-processed samples could also contribute to the cloudy appearance seen in FIG. 2 since a surface with roughness comparable to the wavelength spectrum of visible light would result in more scattering. The acetic acid-processed samples, on the other hand, are expected to have much lower scattering since the surface features are much smaller than the wavelength spectrum of visible light.

Materials and Methods

Polymer and Chemicals.

The PHB (98%) used in the work was obtained as thermally processed pellets (BRS Bulk Bio-pellets, Bulk Reef Supply, Golden Valley, USA). The PHB pellets were washed with isopropyl alcohol to prevent microbial contamination and otherwise used as received. Acetic acid (99%) and chloroform (99%) were obtained from Sigma-Aldrich, Canada and used as received. The chemical composition and melting point of as-received PHB was determined using x-ray photoelectron spectroscopy (XPS), CHNS analysis, and differential scanning calorimetry (DSC). The XPS results showed that the as-received material contained ˜1 wt. % Si, which likely remained in the sample as impurity after the pelletization of PHB. We found that the C:O ratio of the as-received polymer was within 1% from the theoretical ratio (C:O ratio of 1.5) of pure PHB. These numbers are consistent with a PHB purity of 98-99%. The melting point of the as-received PHB at a heating rate of 10° C./min was found to be ˜180° C., which agrees well with the values reported for PHB in the literature.

PHB Film Preparation.

The PHB pellets were mixed with acetic acid and heated to boiling in a covered beaker under constant stirring until the sample was completely dissolved (typically ˜40 to 60 minutes). A polymer solution with a concentration of 0.05 g/ml of PHB in acetic acid was used to prepare all test films. Approximately 4.5-5 ml of polymer solution previously brought to the required casting temperature was poured on a pre-heated glass slide (70 mm×35 mm) maintained at the required casting temperature (80° C., 100° C., 120° C., 140° C. or 160° C.) (FIG. 1b). Films were obtained after complete evaporation of the solvent (FIG. 1c). The solvent casting time was varied based on the boiling point of acetic acid (118° C.): samples cast at temperatures above 118° C. were dried for 3 minutes, whereas the samples cast at temperatures below 118° C. were dried for 6 minutes to ensure complete removal of solvent. The prepared film samples were stored at room temperature for 24 hours prior to characterization.

As a comparative sample, PHB was solvent cast using chloroform. PHB was dissolved in chloroform at 70° C. for 1 hour and then poured onto glass slides at room temperature; the solution was dried at 25° C. for 24 hours to prepare film samples. The samples were aged for five days at atmospheric pressure and room temperature, and then vacuum dried for 3 hours to remove most of the residual chloroform.

Elemental Analysis.

The chemical composition of the as-received PHB material was characterized using an Axis Ultra (Kratos Analytical) X-ray photoelectron spectrometer (XPS) and a Carlo Erba EA1108 Elemental Analyzer for CHNS and oxygen detection. XPS was carried out over binding energy values ranging from 0 eV to 1500 eV, at a scan rate and energy step of 2 eV/second and 400 meV, respectively.

The areas of peaks corresponding to given elemental bonds were used to determine the chemical composition of the sample. CHNS analysis was carried out following a modified form of the Pregl-Dumas technique. The C:O and C:H ratios were used to confirm the purity of the as-received material.

Optical Transmittance.

The optical transmittance of the PHB samples was characterized using a Perkin-Elmer Lambda 900 NIR-UV-Vis spectrometer with an integrating sphere and optical bench attachment. The PHB samples were mounted in front of the integrating sphere perpendicular to the path of the incident light beam so that all the light transmitted through the sample was captured by the detector. The transmittance was determined for wavelengths ranging from 300 nm to 800 nm.

X-Ray Diffraction (XRD).

The crystallinity was determined using a Rigaku X-ray diffraction (XRD) system in glancing incidence angle mode. The scan was carried out between 5° and 60° at a rate of 2°/min using Cu Kα X-rays at 44 kV. An Ultima VI goniometer fitted with a thin film attachment was used to characterize the samples. An X-ray beam spot of 5 mm diameter was used for all scans. The samples were attached to a glass slide and kept as flat as possible. Baseline correction and de-convolution of the amorphous halo from the actual XRD pattern were carried out using Igor Pro 6.35A5. The area under the crystalline peak was used as a measure of overall crystallinity of samples cast at different temperatures.

The crystallinity percentage with respect to solvent casting temperature was plotted and compared with results obtained using chloroform.

Thermogravimetric Analysis (TGA).

The extent of thermal degradation due to dissolution and processing of PHB in acetic acid was determined using a Mettler Toledo TGA/DSC 1 system. TGA scans were carried out from 25° C. to 380° C., at a heating rate of 10° C./minute. The temperature of complete degradation and the range of temperatures over which the degradation occurred were used to determine the extent of degradation.

Differential Scanning Calorimetry (DSC).

The melting temperature and the shape of the melting endotherm of the base material and processed samples were determined using a differential scanning calorimeter (DSC). The DSC was calibrated using indium and zinc standards. At least 5 mg of sample were used for each run, and closed aluminum pans were used for the samples. DSC analysis was carried out from 25° C. to 195° C. at a heating rate of 10° C./min for the as-received material. While, the heating rate was maintained at 20° C./min for the DSC runs of all solvent cast films. This was done to limit the extent of recrystallization and thermal effects during the heating cycle.

Tensile Testing.

The PHB films were sectioned into rectangular samples of dimensions 25 mm×5±0.5 mm×55±8 μm (length×width×thickness). An Instron 5943 tensile tester with a 1 kN load cell was used to carry out all tests. Data was collected at a strain rate of 0.5 mm/min. For each casting temperature, at least four samples were tested, and the average (with standard error) was plotted with respect to the processing temperature. The elastic modulus was obtained by measuring the slope over the linear region of the stress-strain curve.

Atomic Force Microscopy (AFM).

The surface morphology and the root mean square roughness (RMS) of solvent cast PHB surfaces were determined using a Bruker Nano Dimension Edge atomic force microscope (AFM). The AFM was operated in tapping mode using a tip with a spring constant of 40 N/m. Characterization of each sample was carried out on the smooth, cast surface obtained when the sample was peeled away from the glass slide. The RMS roughness over an area of 3 μm² was obtained at five relatively flat regions free from any visible voids.

### Definitions and Interpretation

The singular forms “a,” “an,” and “the” include plural reference unless the context clearly dictates otherwise. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation.

The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by the skilled artisan, all numbers, including those expressing quantities of reagents or ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

### REFERENCES

The following references are referred to above by a numeral within square brackets, and are incorporated herein in their entirety by reference, where permitted.
1. Kumagai, Y., Kanesawa, Y. & Doi, Y. Enzymatic degradation of microbial poly(3-hydroxybutyrate) films. Macromol. Chem. 193, 53-57 (1992).
2. Yoshie, N., Oike, Y., Kasuya, K., Doi, Y. & Inoue, Y. Change of Surface Structure of Poly(3-hydroxybutyrate) Film upon Enzymatic Hydrolysis by PHB Depolymerase. Biomacromolecules 3, 1320-1326 (2002).
3. Orts, W. J. et al. Poly(hydroxyalkanoates): Biorefinery polymers with a whole range of applications. The work of Robert H. Marchessault. Can. J. Chem. 86, 628-640 (2008).
4. Philip, S., Keshavarz, T. & Roy, I. Polyhydroxyalkanoates: biodegradable polymers with a range of applications. J. Chem. Technol. Biotechnol. 82, 233-247 (2007).
5. Zinn, M., Witholt, B. & Egli, T. Occurrence, synthesis and medical application of bacterial polyhydroxyalkanoate. Adv. Drug Deliv. Rev. 53, 5-21 (2001).
6. Kai, D. & Loh, X. J. Polyhydroxyalkanoates: Chemical Modifications Toward Biomedical Applications. ACS Sustain. Chem. Eng. 2, 106-119 (2014).
7. Bucci, D. Z., Tavares, L. B. B. & Sell, I. PHB packaging for the storage of food products. Polym. Test. 24, 564-571 (2005).
8. Loh, X. J., Goh, S. H. & Li, J. Hydrolytic degradation and protein release studies of thermogelling polyurethane copolymers consisting of poly[(R)-3-hydroxybutyrate], poly(ethylene glycol), and poly(propylene glycol). Biomaterials 28, 4113-4123 (2007).
9. Loh, X. J., Zhang, Z.-X., Wu, Y.-L., Lee, T. S. & Li, J. Synthesis of Novel Biodegradable Thermoresponsive Triblock Copolymers Based on Poly[(R)-3-hydroxybutyrate] and Poly(N-isopropylacrylamide) and Their Formation of Thermoresponsive Micelles. Macromolecules 42, 194-202 (2009).
10. Wang, L. et al. Processability modifications of poly(3-hydroxybutyrate) by plasticizing, blending, and stabilizing. J. Appl. Polym. Sci. 107, 166-173 (2008).
11. Miller, N. D. & Williams, D. F. On the biodegradation of poly-β-hydroxybutyrate (PHB) homopolymer and poly-β-hydroxybutyratehydroxyvalerate copolymers. Biomaterials 8, 129-137 (1987).
12. Barham, P. J., Barker, P. & Organ, S. J. Physical properties of poly(hydroxybutyrate) and copolymers of hydroxybutyrate and hydroxyvalerate. FEMS Microbiol. Lett. 103, 280-298 (1992).
13. Bauer, H. & Owen, A. J. Some structural and mechanical properties of bacterially produced poly-β-hydroxybutyrateco-β-hydroxyvalerate. Colloid Polym. Sci. 266, 241-247 (1988).
14. Koyama, N. & Doi, Y. Morphology and biodegradability of a binary blend of poly((R)-3-hydroxybutyric acid) and poly((R,S)-lactic acid). Can. J. Microbiol. 41, 316-322 (1995).
15. Zhang, M. & Thomas, N. L. Blending polylactic acid with polyhydroxybutyrate: The effect on thermal, mechanical, and biodegradation properties. Adv. Polym. Technol. 30, 67-79 (2011).
16. Savenkova, L. et al. Mechanical properties and biodegradation characteristics of PHB-based films. Process Biochem. 35, 573-579 (2000).
17. Sauvageau, D., Cooper, D. G. & Nicell, J. A. Relative rates and mechanisms of biodegradation of diester plasticizers mediated by Rhodococcus rhodochrous. Can. J. Chem. Eng. 87, 499-506 (2009).
18. Nalli, S., Cooper, D. G. & Nicell, J. A. Metabolites from the biodegradation of di-ester plasticizers by Rhodococcus rhodochrous. Sci. Total Environ. 366, 286-294 (2006).
19. Yang, C. Z., Yaniger, S. I., Jordan, V. C., Klein, D. J. & Bittner, G. D. Most Plastic Products Release Estrogenic Chemicals: A Potential Health Problem That Can Be Solved. Environ. Health Perspect. 119, 989-996 (2011).
20. Fasano, E., Bono-Blay, F., Cirillo, T., Montuori, P. & Lacorte, S. Migration of phthalates, alkylphenols, bisphenol A and di(2-ethylhexyl)adipate from food packaging. Food Control 27, 132-138 (2012).
21. Erythropel, H. C., Maric, M., Nicell, J. A., Leask, R. L. & Yargeau, V. Leaching of the plasticizer di(2-ethylhexyl)phthalate (DEHP) from plastic containers and the question of human exposure. Appl. Microbiol. Biotechnol. 98, 9967-9981 (2014).
22. Janigová, I., Lací k, I. & Chodák, I. Thermal degradation of plasticized poly(3-hydroxybutyrate) investigated by DSC. Polym. Degrad. Stab. 77, 35-41 (2002).
23. Erceg, M., Kova\check{c}ić, T. & Klarić, I. Thermal degradation of poly(3-hydroxybutyrate) plasticized with acetyl tributyl citrate. Polym. Degrad. Stab. 90, 313-318 (2005).
24. Cyras, V. P., Commisso, M. S., Mauri, A. N. & Vázquez, A. Biodegradable double-layer films based on biological resources: Polyhydroxybutyrate and cellulose. J. Appl. Polym. Sci. 106, 749-756 (2007).
25. Seoane, I. T., Manfredi, L. B. & Cyras, V. P. Properties and Processing Relationship of Polyhydroxybutyrate and Cellulose Biocomposites. Procedia Mater. Sci. 8, 807-813 (2015).
26. Díez-Pascual, A. M. & Díez-Vicente, A. L. Poly(3-hydroxybutyrate)/ZnO Bionanocomposites with Improved Mechanical, Barrier and Antibacterial Properties. Int. J. Mol. Sci. 15, 10950-10973 (2014).
27. Siemann, U. Solvent cast technology—a versatile tool for thin film production. Progress in Colloid and Polymer Science. Vol. 130, pp 1-14 (2005).
28. Takeda, R. & Shiraishi, H. Process for producing cellulose triacetate film. U.S. Pat. No. 5,152,947 (1992).
29. Bermel, M. S. Polyvinyl alcohol films prepared by coating methods. U.S. Pat. No. 7,163,738 (2007).
30. Terada, M. & Marchessault, R. H. Determination of solubility parameters for poly(3-hydroxyalkanoates). Int. J. Biol. Macromol. 25, 207-215 (1999).
31. Jacquel, N., Lo, C.-W., Wu, H.-S., Wei, Y.-H. & Wang, S. S. Solubility of polyhydroxyalkanoates by experiment and thermodynamic correlations. AIChE J. 53, 2704-2714 (2007).
32. Tardiff, R. G. Health Effects of Organics: Risk and Hazard Assessment of Ingested Chloroform. J. Am. Water Works Assoc. 69, 658-661 (1977).
33. Weisel, C. P. & Jo, W. K. Ingestion, inhalation, and dermal exposures to chloroform and trichloroethene from tap water. Environ. Health Perspect. 104, 48 (1996).
34. Prat, D., Hayler, J. & Wells, A. A survey of solvent selection guides. Green Chem. 16, 4546-4551 (2014).
35. Cheung, H., Tanke, R. S. & Torrence, G. P. Acetic Acid, Ullmann's encyclopedia of industrial chemistry (Wiley Online Library, 2011).
36. Kim, Meera. Antimicrobial Activity of PHB/Chitosan Films and Quality of White Bread Packaged with the Films. Korean J. Hum. Ecol. 14, 321-330 (2005).
37. Yalpani, M., Marchessault, R. H., Morin, F. G. & Monasterios, C. J. Synthesis of poly(3-hydroxyalkanoate) (PHA) conjugates: PHA-carbohydrate and PHA-synthetic polymer conjugates. Macromolecules 24, 6046-6049 (1991).
38. Yalpani, M. Functionalized poly(hydroxyalkanoates) and method of manufacturing same. U.S. Pat. No. 5,191,016 (1993).
39. Van de Witte, P., Dijkstra, P. J., van den Berg, J. W. A. & Feijen, J. Phase separation processes in polymer solutions in relation to membrane formation. J. Membr. Sci. 117, 1-31 (1996).
40. Gazzano, M., Tomasi, G. & Scandola, M. X-ray investigation on melt-crystallized bacterial poly(3-hydroxybutyrate). Macromol. Chem. Phys. 198, 71-80 (1997).
41. Hurrell, B. L. & Cameron, R. E. A wide-angle X-ray scattering study of the ageing of poly(hydroxybutyrate). J. Mater. Sci. 33, 1709-1713 (1998).
42. Holmes, P. A. Applications of PHB—a microbially produced biodegradable thermoplastic. Phys. Technol. 16, 32 (1985).
43. Sauer, B. B., Kampert, W. G., Neal Blanchard, E., Threefoot, S. A. & Hsiao, B. S. Temperature modulated DSC studies of melting and recrystallization in polymers exhibiting multiple endotherms. Polymer 41, 1099-1108 (2000).
44. Hsiao, B. S., Zuo, F., Mao, Y. & Schick, C. Experimental techniques. Handbook of polymer crystallization. 15, 1-30 (John Wiley & Sons, Inc., 2013).
45. Menczel J. D., Judovits L. H., Prime R. B., Bair H. E., Reading M. & Swier S. Differential scanning calorimetry (DSC). Thermal analysis of polymers: Fundamentals and applications. 2, 7-229 (John Wiley & Sons, 2014).
46. Gunaratne, L. M. W. K., Shanks, R. A. & Amarasinghe, G. Thermal history effects on crystallisation and melting of poly(3-hydroxybutyrate). Thermochim. Acta 423, 127-135 (2004).
47. Gunaratne, L. M. W. K. & Shanks, R. A. Multiple melting behaviour of poly(3-hydroxybutyrate-co-hydroxyvalerate) using step scan DSC. Eur. Polym. J. 41, 2980-2988 (2005).
48. El-Hadi, A., Schnabel, R., Straube, E., Müller, G. & Henning, S. Correlation between degree of crystallinity, morphology, glass temperature, mechanical properties and biodegradation of poly (3-hydroxyalkanoate) PHAs and their blends. Polym. Test. 21, 665-674 (2002).
49. Barham, P. J. & Keller, A. The relationship between microstructure and mode of fracture in polyhydroxybutyrate. J. Polym. Sci. Part B Polym. Phys. 24, 69-77 (1986).
50. De Koning, G. J. M., Lemstra, P. J., Hill, D. J. T., Carswell, T. G. & O'Donnell, J. H. Ageing phenomena in bacterial poly[(R)-3-hydroxybutyrate]: 1. A study on the mobility in poly[(R)-3-hydroxybutyrate] powders by monitoring the radical decay with temperature after γ-radiolysis at 77 K. Polymer 33, 3295-3297 (1992).
51. De Koning, G. J. M. & Lemstra, P. J. Crystallization phenomena in bacterial poly[(R)-3-hydroxybutyrate]: 2. Embrittlement and rejuvenation. Polymer 34, 4089-4094 (1993).
52. Schultz, J. M. Microstructural aspects of failure in semicrystalline polymers. Polym. Eng. Sci. 24, 770-785 (1984).
53. Ihnat M. Sample preparation for food analysis, Sample preparation for trace element analysis. 25, 765-856, (Elsevier, 2003).

What is claimed is:

1. A method of forming a polymer film, coating or particle comprising a polyhydroxyalkanoate, comprising the step of dissolving the polymer in a solvent comprising an alkanoic acid, and drying or precipitating the dissolved polymer.

2. The method of claim 1 wherein the polymer comprises polyhydroxybutyrate.

3. The method of claim 2 wherein the solvent comprises acetic acid.

4. The method of claim 3 wherein the solvent comprises glacial acetic acid.

5. The method of claim 4 wherein the polymer is dissolved at or near the boiling point of acetic acid.

6. The method of claim 4 wherein the dissolved polymer is cast at a temperature ranging from about 20° C. to about 180° C.

7. The method of claim 6 wherein the dissolved polymer is cast at a temperature ranging from about 80° C. to about 160° C.

8. The method of claim 6 wherein the casting temperature is chosen to achieve a desired property of the resulting polymer.

9. The method of claim 8 wherein the desired property is a desired crystallinity or a desired optical transmittance.

10. The method of claim 4 wherein the dissolved polymer is precipitated to form a porous polymer.

11. A polyhydroxybutyrate having a characteristic X-ray diffraction peak at a 2θ value of 16.85° or a suppressed peak at a 2θ value of 16.2°, or both.

12. A polyhydroxyalkanoate produced from a solution of the polyhydroxyalkanoate in an alkanoic acid.

13. The polyhydroxyalkanoate of claim 12 comprising polyhydroxybutyrate.

14. The polyhydroxyalkanoate of claim 13 which is cast from the solution at a casting temperature between about 20° C. to about 180° C.

15. The polyhydroxyalkanoate of claim 14 which is cast at a temperature ranging from about 80° C. to about 160° C.

16. The polyhydroxyalkanoate of claim 13 having a crystallinity index greater than the crystallinity index of the polyhydroxyalkanoate produced from a solution in chloroform at 20° C.
